(19) United States
(12) Patent Application Publication
(10) Pub. No.: US 2009/0328230 A1
(43) Pub. Date: Dec. 31, 2009

(54) METHOD AND APPARATUS FOR PLAYING DIGITAL CONTENTS PROCESSED WITH DRM TOOLS

(76) Inventors: Young-Bae Byun, Seoul (KR); Bum-Suk Choi, Daejon (KR); Je-Ho Nam, Daejon (KR); Jin-Woo Hong, Daejon (KR)

Correspondence Address: LADAS & PARRY LLP, 224 SOUTH MICHIGAN AVENUE, SUITE 1600, CHICAGO, IL, 60604, US

(21) Appl. No.: 12/297,897

(22) PCT Filed: Apr. 20, 2007
(86) PCT No.: PCT/KR07/01946

§ 371 Date: Jun. 24, 2009

(30) Foreign Application Priority Data
Apr. 21, 2006 (KR) 10-2006-0036397

(51) Int. Cl. G06F 21/00

(52) U.S. Cl. 726/26

(57) ABSTRACT

Provided is a terminal in support of compatibility for Digital Rights Management (DRM) technology. According to the present invention, a method of reproducing digital contents with DRM tool at a user terminal includes the steps of: obtaining information about a DRM processor from the digital contents, selecting a DRM processor according to the obtained information, and installing the selected DRM processor; initializing the DRM processor through exchanging messages between the user terminal and the DRM processor; and transforming the digital contents with the DRM tool to original digital contents by activating a DRM tool using the initialized DRM processor and reproducing the original digital contents.

### TECHNICAL FIELD

The present invention relates to a method and apparatus for reproducing digital contents; and, more particularly, to a method and apparatus for supporting compatibility of Digital Rights Management (DRM) tools and reproducing digital contents.

### BACKGROUND ART

A conventional Digital Rights Management (DRM) technology has a problem of limiting the use of digital contents with a DRM tool applied thereto because different technical specifications were applied to digital contents by services, devices, and manufacturers. Such a problem has been a major obstacle to revitalize a digital content industry.

As shown in FIG. 1, a terminal without a DRM tool applied thereto performs only a set of sequential processes for decoding and rendering broadcasting or digital contents inputted from a storage device.

As shown in FIG. 2, a terminal with a DRM tool applied thereto analyzes an applied DRM tool and decodes the DRM before reproducing digital contents by using the same method shown in FIG. 1. That is, the DRM tool applied terminal includes a DRM processor for performing a sequence of processes for analyzing a DRM tool and decoding DRM as well as a process for reproducing digital contents like a content reproducing apparatus. The content reproducing apparatus may be equivalent to a terminal without a DRM tool applied thereto.

A terminal having a DRM process was introduced in Korean patent application No. 2006-30312, filed on Apr. 3, 2006, and entitled “Tool Pack Structure and Contents Execution Device.” In the cited Korean patent application, the DRM process analyzes the DRM information of corresponding digital content, searches a proper tool pack, transforms digital contents protected by the tool pack to original digital contents, and reproduces the original digital contents.

Since a DRM analysis method differs according to a DRM tool applied to digital content, a DRM processor is dependent on the DRM tool applied to digital contents. For example, in order to reproduce contents with Digital Media Project (DMP) DRM applied, a DMP DRM terminal is needed. When MPEG-2 IPMP is applied to digital contents, a MPEG-2 IPMP terminal is needed to reproduce the MPEG-2 IPMP digital contents. Similarly, other DRM technologies need corresponding DRM terminals.

### DISCLOSURE

### Technical Problem

An embodiment of the present invention is directed to providing a DRM terminal for supporting mutual compatibility of DRM tools.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method of reproducing digital contents with Digital Rights Management (DRM) tool at a user terminal, which includes the steps of: obtaining information about a DRM processor from the digital contents, selecting a DRM processor according to the obtained information, and installing the selected DRM processor; initializing the DRM processor through exchanging messages between the user terminal and the DRM processor; and transforming the digital contents with the DRM tool to original digital contents by activating a DRM tool using the initialized DRM processor and reproducing the original digital contents.

In accordance with another aspect of the present invention, there is provided an apparatus for reproducing digital contents with a DRM tool applied, which includes: a DRM processor selected and driven according to DRM processor information obtained from the digital contents for activating a DRM tool according to the digital contents and transforming the digital contents with the DRM tool to original digital contents; an initialization means for initializing the DRM processor through exchanging messages with the DRM processor; and a reproduction means for reproducing the digital contents transformed by the DRM processor.

In accordance with another aspect of the present invention, there is provided a data structure for storing information about a DRM processor in a digital content reproducing apparatus, which includes: an identifier of the DRM processor; and a Uniform Resource Locator (URL) of a remote server from which the DRM processor is download, or a binary code of the DRM processor.

In accordance with another aspect of the present invention, there is provided a method for initializing a DRM processor in a digital content reproducing apparatus having the DRM processor according to input digital contents, which includes the steps of: transferring a message to the digital content reproducing apparatus from the DRM processor for asking whether the digital contents are broadcasting contents or not; and transferring a message from the digital content reproducing apparatus to the DRM processor for responding to the transferred message.

In accordance with another aspect of the present invention, there is provided a method for initializing a DRM processor in a digital content reproducing apparatus having the DRM processor according to input digital contents, which includes the steps of: transferring a message to the user terminal by the DRM processor for requesting data size if the digital content is a file type or a packet identifier PID if the digital contents are broadcasting or multicasting, as data including DRM information; and transferring a message transferred to the DRM processor by the user terminal for responding to the message.

In accordance with another aspect of the present invention, there is provided a method for initializing a DRM processor in a digital content reproducing apparatus having the DRM processor according to input digital contents, which includes the steps of: transferring a message to the user terminal by the DRM processor for asking where additional information of the DRM is stored in the user terminal; and transferring a message to the DRM processor by the user terminal for responding to the message.

In accordance with another aspect of the present invention, there is provided a method for initializing a DRM processor in a digital content reproducing apparatus having the DRM processor according to input digital contents, which includes the step of: transferring a message to the user terminal by the DRM processor for informing that the DRM processor is ready to reproduce contents.

### ADVANTAGEOUS EFFECTS

A DRM terminal according to an embodiment of the present invention can support compatibility among DRM tools by obtaining a DRM processor according to a DRM tool applied to predetermined digital contents and initializing a DRM processor through exchanging standard messages.

### BRIEF DESCRIPTION OF THE DRAWINGS

FIG. 1 illustrates a terminal with a DRM not applied thereto in accordance with a related art.

FIG. 2 depicts a DRM terminal in accordance with the related art.

FIG. 3 is a diagram showing a DRM terminal for supporting compatibility among DRM tools in accordance with an embodiment of the present invention.

FIG. 4 is a flowchart describing a method of reproducing digital contents in accordance with an embodiment of the present invention.

FIG. 5 illustrates an XML schema structure of a DRM process in accordance with an embodiment of the present invention.

FIG. 6 is a flowchart describing a method of reproducing digital contents in accordance with an embodiment of the present invention.

FIG. 7 illustrates an authentication initializing message in accordance with an embodiment of the present invention.

FIG. 8 illustrates a mutual authentication message in accordance with an embodiment of the present invention.

FIG. 9 illustrates a service type requesting message in accordance with an embodiment of the present invention.

FIG. 10 illustrates a service type sending message in accordance with an embodiment of the present invention.

FIG. 11 illustrates a part requesting message in accordance with an embodiment of the present invention.

FIG. 12 illustrates a part sensing message in accordance with an embodiment of the present invention.

FIG. 13 illustrates an additional information location requesting message in accordance with an embodiment of the present invention.

FIG. 14 illustrates an additional information location sending message in accordance with an embodiment of the present invention.

FIG. 15 illustrates a reproducing preparing message in accordance with an embodiment of the present invention.

FIG. 16 illustrates a protected contents sending message in accordance with an embodiment of the present invention.

FIG. 17 illustrates a content sending message in accordance with an embodiment of the present invention.

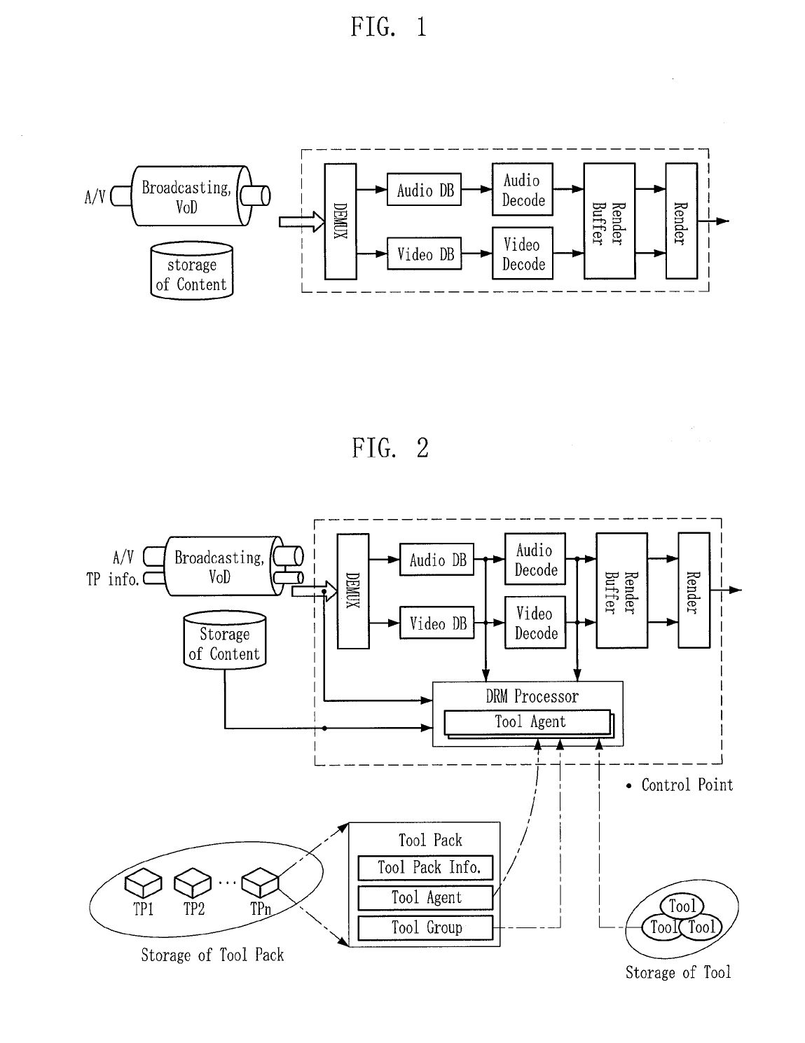

### BEST MODE FOR THE INVENTION

The advantages, features and aspects of the invention will become apparent from the following description of the embodiments with reference to the accompanying drawings, which is set forth hereinafter.

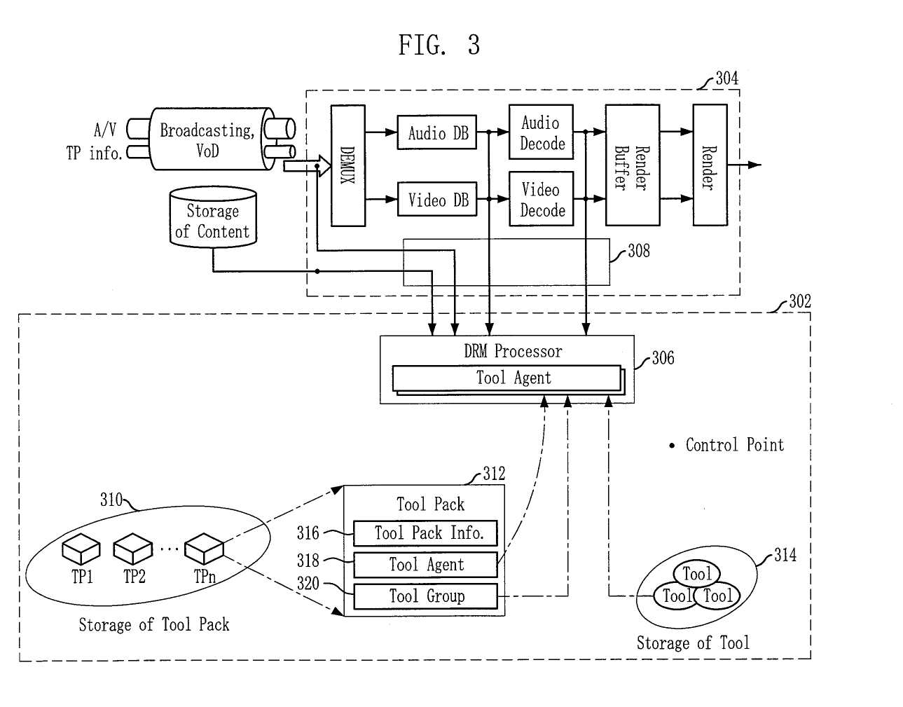

FIG. 3 is a diagram illustrating a DRM terminal for supporting compatibility among DRM tools in accordance with an embodiment of the present invention.

Referring to FIG. 3, a DRM processor 306 according to the present embodiment is embodied independently from a content reproducing apparatus 304 in order to support compatibility in a terminal level. In FIG. 3, the DRM processor 306 is disposed in a DRM region 302, which is the outside of the content reproducing apparatus 304 to clearly describe the DRM process 306 embodied independently from the content reproducing apparatus 304. Also, a standard interface is disposed between the content reproducing apparatus 304 and the DRM processor 306.

The DRM processor 306 performs a pre-process for using protected digital contents, searches a tool pack to decode Digital Rights Management (DRM), drives a tool agent, and helps the tool agent and the content reproducing apparatus 304 to communicate with each other. The DRM processor 306 is selectively driven by a controller 308 according to a DRM technology applied to the digital contents.

The DRM processor 306 is initialized by exchanging messages with the controller 308 of the content reproducing apparatus 304. Then, the DRM processor 306 extracts DRM information from inputted digital contents, analyzes the extracted DRM information, and selects and activates a necessary tool pack 312 stored in a storage device 310 based on the analysis result. If the necessary tool pack 312 is not in the storage device 310, the DRM processor 306 accesses to a tool server and downloads the necessary tool pack from the tool server. The DRM processor 306 may store an open tool program, which is frequently and repeatedly used, among a plurality of tool packs in an additional storage device 314, thereby improving the efficiency of storing the tool pack data.

The tool pack 312 includes tool pack information 316, a tool agent 318, and a tool group 320. The tool pack information 316 is information about hardware that the tool pack 312 can use. The tool agent 318 is a program activated by the DRM processor 306 in order to execute contents. It is preferred to provide one tool agent 318 per each tool pack. It is also preferred to previously activate a corresponding tool agent when it is required to execute content data that needs a corresponding tool pack. The tool group 320 includes at least one of tool programs in order to process contents based on a predetermined rule of a content tool after being activated by the tool agent 318. The tool program is a program for individually encoding and decoding contents. The activated tool agent 318 can call at least one of tool programs and assign necessary encoding/decoding processes to the called tool programs while performing processes.

It is preferred to open the specifications of the tool agent 318, for example, interfaces, parameters, and return variables, to the public to provide convenience to the manufacturers of external devices and application programs related to encoded content data. However, if the specifications of the tool agent 318 are not opened to the public, the enhanced security for converting contents data can be provided without inconvenience given to manufacturers of external devices or application programs because the tool program is called by only the tool agent 318.

In FIG. 3, control points “” denote points where DRM tools can be applied in each of steps for processing contents, for example, reproducing, storing, and transmitting the contents, from a time of inputting the contents in the content reproducing apparatus 304. The tool agent 318 calls necessary DRM tools from a tool group 320 and connects the called DRM tools to proper control points.

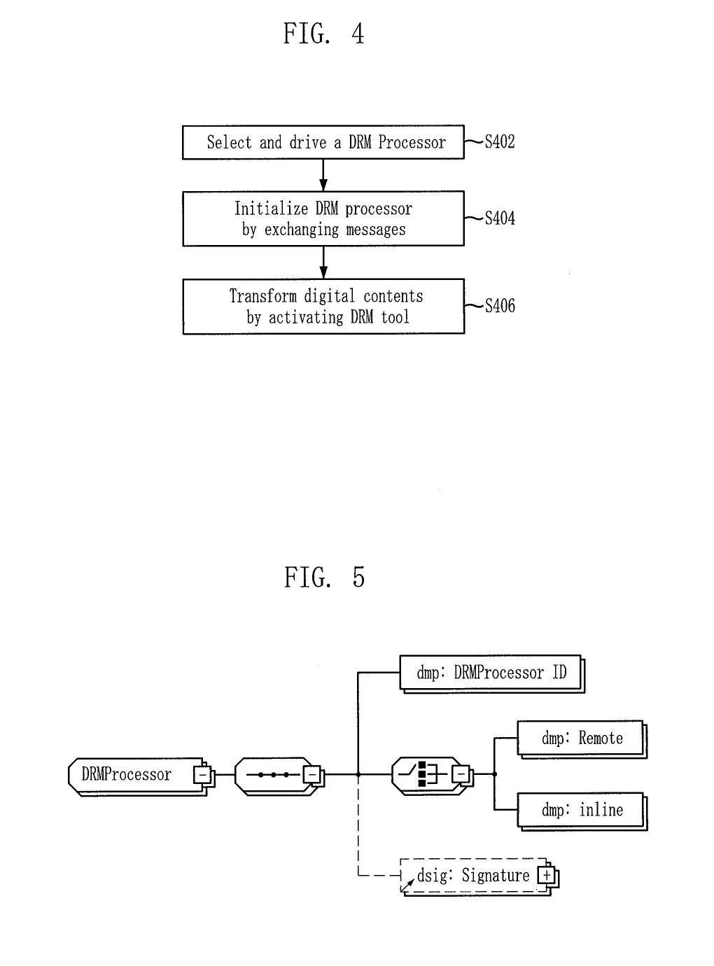

FIG. 4 is a flowchart illustrating a method of reproducing digital content in accordance with an embodiment of the present invention.

At first, information related to a DRM processor is obtained from inputted digital contents, a corresponding DRM processor is selected according to the DRM processor information, and the selected DRM processor is driven at step S402.

FIG. 5 is a diagram illustrating an XML schema of a DRM processor in accordance with an embodiment of the present invention.

A DRM terminal XML schema includes a DRM terminal ID, a DRM terminal address, a binary DRM terminal code, and a signature. The XML schema of a DRM processor is parsed by a terminal. Table 1 describes each element of the DRM processor XML schema.

TABLE 1

| Element name | Description |
|---|---|
| DRM processor | It is an identification of a DRM |
| ID | processor. The ID is issued by a tool |
| | register server when a DRM is |
| | registered at the tool register server. |
| Remote | It denotes a URL of a remote server to |
| | access for downloading a DRM processor. |
| Inline | It includes a binary code for a DRM |
| | processor. |
| Signature | It is an element for authenticating and |
| | confirming data integrity. |

At step S404, the DRM processor 306 is initialized through exchanging messages between the content reproducing apparatus 304 and the DRM processor 306. At step S406, digital contents with a DRM tool applied are transformed to original digital contents by activating a DRM tool using the DRM processor 306. Then, the original digital contents are reproduced.

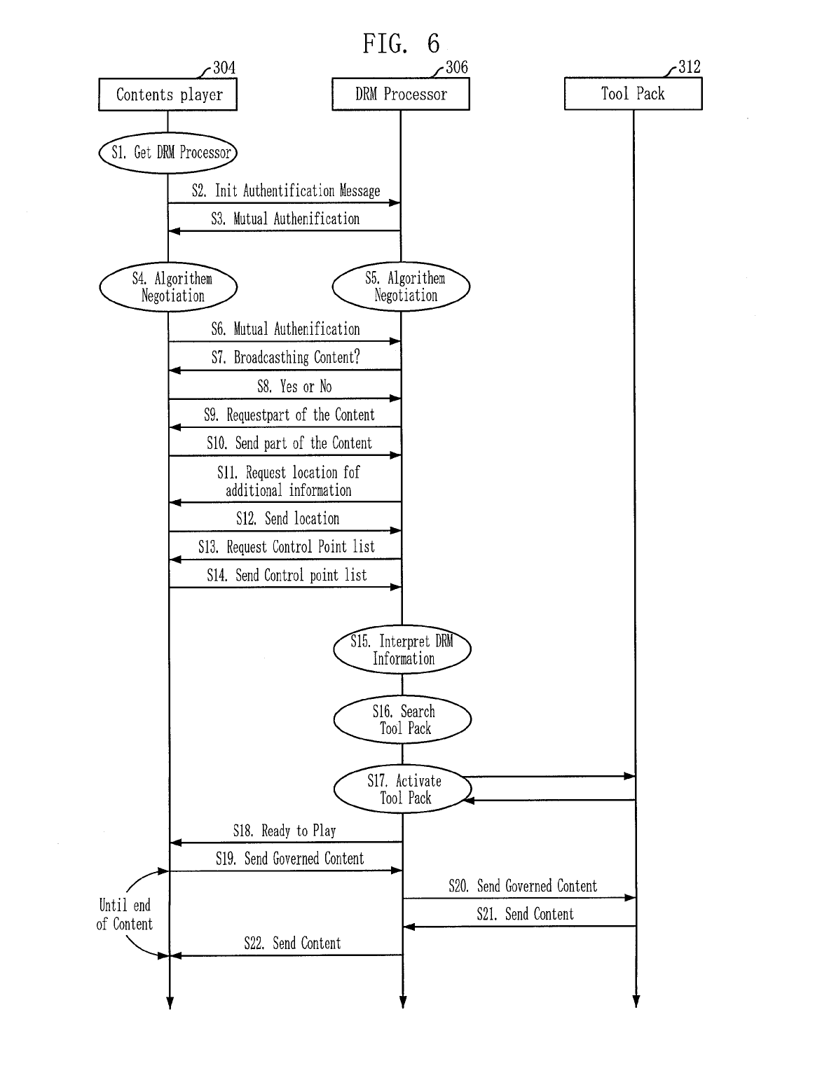

FIG. 6 is a flowchart illustrating a method for reproducing contents in accordance with an embodiment of the present invention.

At first, the content reproducing apparatus 304 obtains a DRM processor 306 according to digital contents and drives the obtained DRM processor 306 at step S1. The DRM processor 306 may be downloaded from an external server if the corresponding DRM processor 306 is not stored in the content reproducing apparatus 304.

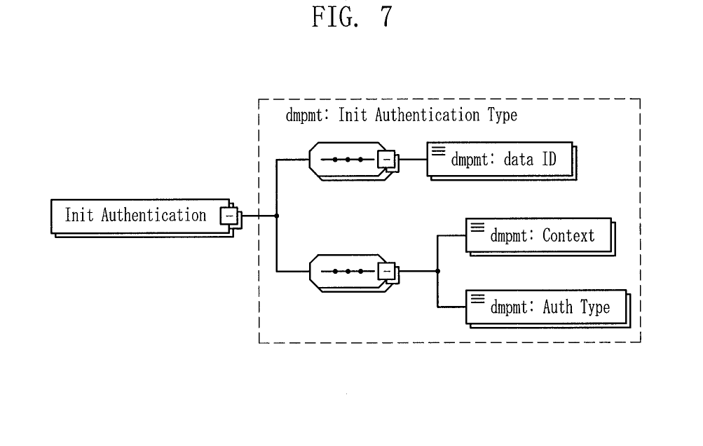

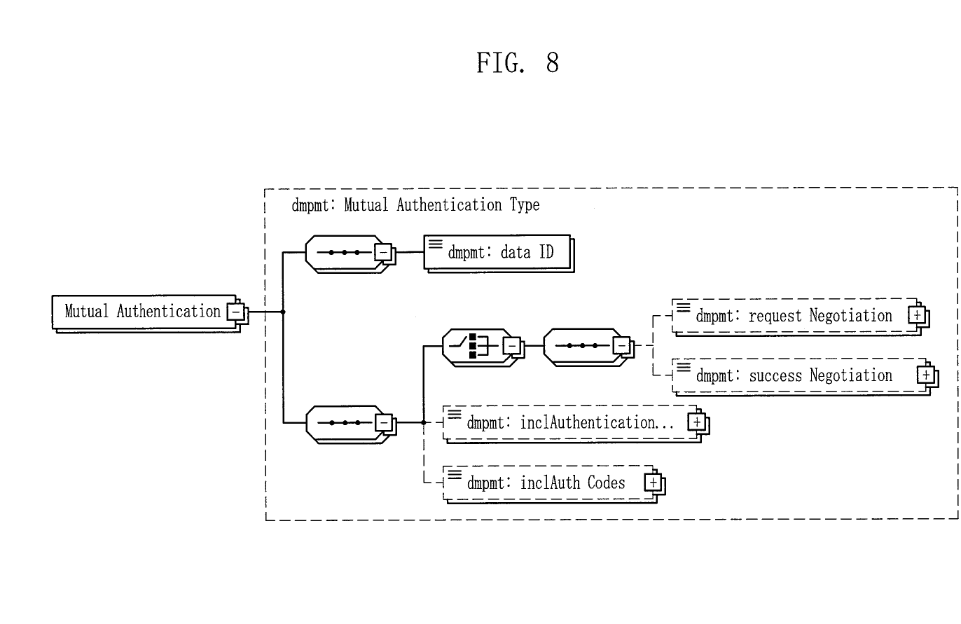

At step S2, the content reproducing apparatus 304 transmits an authentication initializing message to the DRM processor 306. At step S3, the DRM processor 306 transmits a mutual authentication message to the content reproducing apparatus 304. The content reproducing apparatus 304 and the DRM processor 306 perform an algorithm negotiation process at steps S4 and S5. The content reproducing apparatus 304 transmits a mutual authentication message to the DRM processor 306 at step S6. FIG. 7 illustrates an XML schema structure of the authentication initializing message, and FIG. 8 illustrates an XML schema structure of the mutual authentication message.

Then, the DRM processor 306 is initialized through exchanging messages between the DRM processor 306 and the content reproducing apparatus 304 at step S2 through S12.

The DRM processor 306 transmits a content service type requesting message to the content reproducing apparatus 304 in order to ask whether contents are broadcasting contents or not at step S7. In response to the content service type requesting message, the contents reproducing apparatus 304 transmits a content service type sending message to the DRM processor 306 as an answer of “yes” or “no” at step S8.

In case of the broadcasting service, for example in case of receiving digital contents through a broadcasting network, it is more efficient to de-multiplex a transport stream using the content reproducing apparatus 304 than the DRM processor. In case of using a download type service or using file type contents stored in a storage device, the content reproducing apparatus cannot recognize a package type. Therefore, the DRM processor must extract DRM information from contents. That is, the DRM processor 406 asks a content service type to the content reproducing apparatus 304.

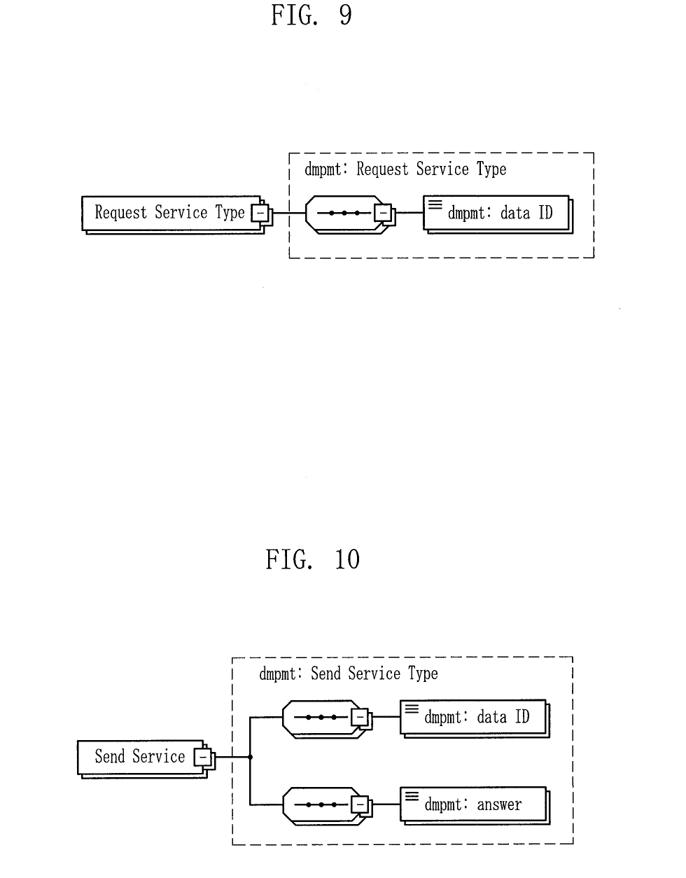

FIG. 9 is a diagram illustrating an XML schema structure of the content service type requesting message transmitted at the step S7, and FIG. 10 shows an XML schema structure of the content service type sending message transmitted at the step S8.

Then, the DRM processor 306 transmits a part requesting message to the content reproducing apparatus 304 at step S9, and the content reproducing apparatus 304 transmits a part sending message to the DRM processor 306 at step S10.

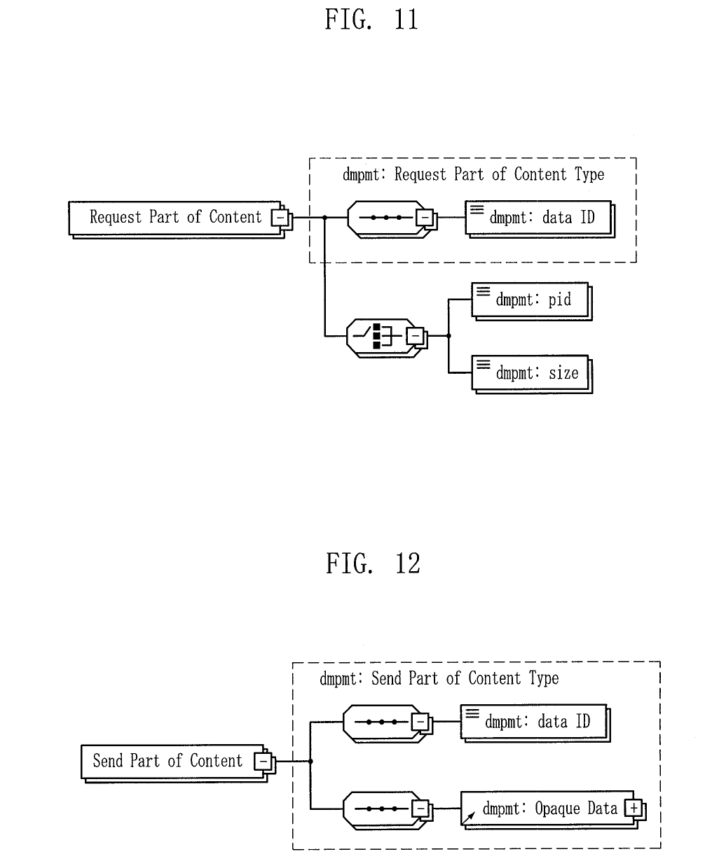

The DRM information may be included in a predetermined part of the contents. In this case, the DRM processor 306 needs the predetermined part of the contents, which includes the DRM information, in order to obtain the DRM information. That is, the DRM processor obtains the DRM information included in the predetermined part of the contents through these steps. For example, the predetermined part of the contents can be obtained using message structures shown in FIGS. 11 and 12. As shown in the part requesting message of FIG. 11, the DRM processor transmits packet ID information to the content reproducing apparatus if the contents are broadcasting or multicast stream. If the contents are a file type, the DRM processor transmits data size information to the content reproducing apparatus. As shown in the part sending message of FIG. 12, the content reproducing apparatus transmits a predetermined packet corresponding to the received packet ID information such as PID or the received data size information. Herein, the data size information represents the data including DRM information using the beginning of the data and the data size thereof. The steps of transmitting the part requesting message and the part sending message may be repeatedly performed until the DRM processor obtains entire DRM information.

FIG. 11 illustrates an XML schema structure of the part requesting message transmitted at the step S9, and FIG. 12 illustrates an XML schema of the part sending message which is transmitted at step S10. That is, the terminal transmits information requested by the DRM processor in the form like the part sending message shown in FIG. 12.

Then, the DRM processor 306 transmits an additional information locating requesting message for asking a location of DRM additional information to the content reproducing apparatus 304 at step S11. The content reproducing apparatus 304 transmits an additional information location sending message for transmitting the additional location information to the DRM processor 306 at step S12.

Since the DRM processor 306 does not know where the additional information is stored such as the location of a license or a tool in a storage device, the DRM processor 306 asks the terminal where the additional information is stored. If the DRM information includes all of additional information, or if the additional information is included in an external Uniform Resource Locator (URL), the additional information location requesting message is not transmitted.

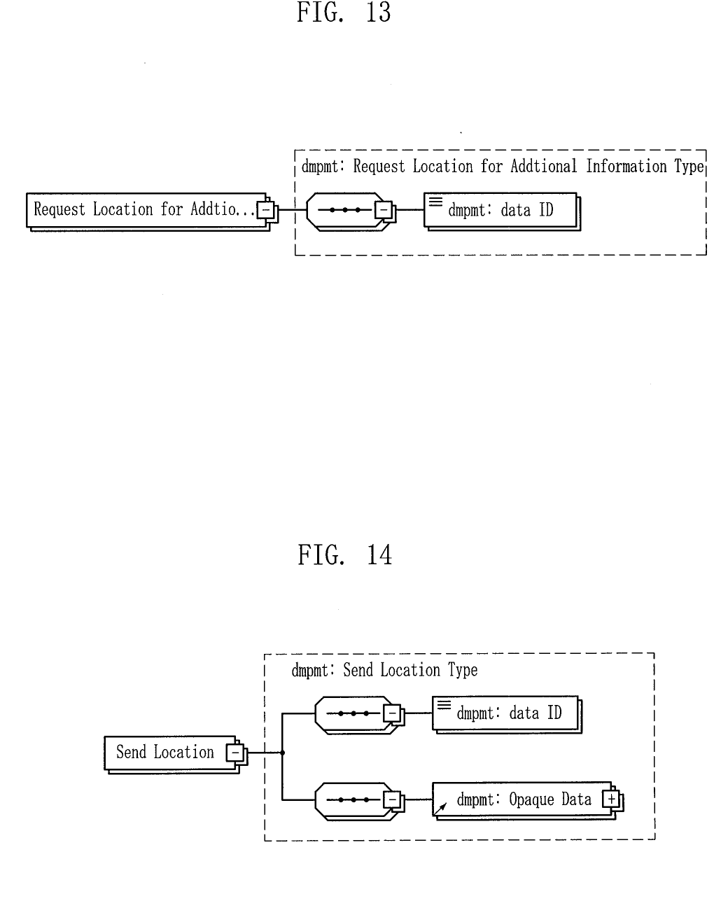

FIG. 13 illustrates an XML schema structure of the additional information location requesting message transmitted at the step S11, and FIG. 14 illustrating an XML schema structure of the additional information location sending message transmitted at the step S12.

Then, the DRM processor 306 transmits a control point list requesting message for requesting a control point list to the content reproducing apparatus 304 at step S13. In response to the control point lint requesting message, the content reproducing apparatus 304 transmits a control point list sending message to the DRM processor 306 at step S14.

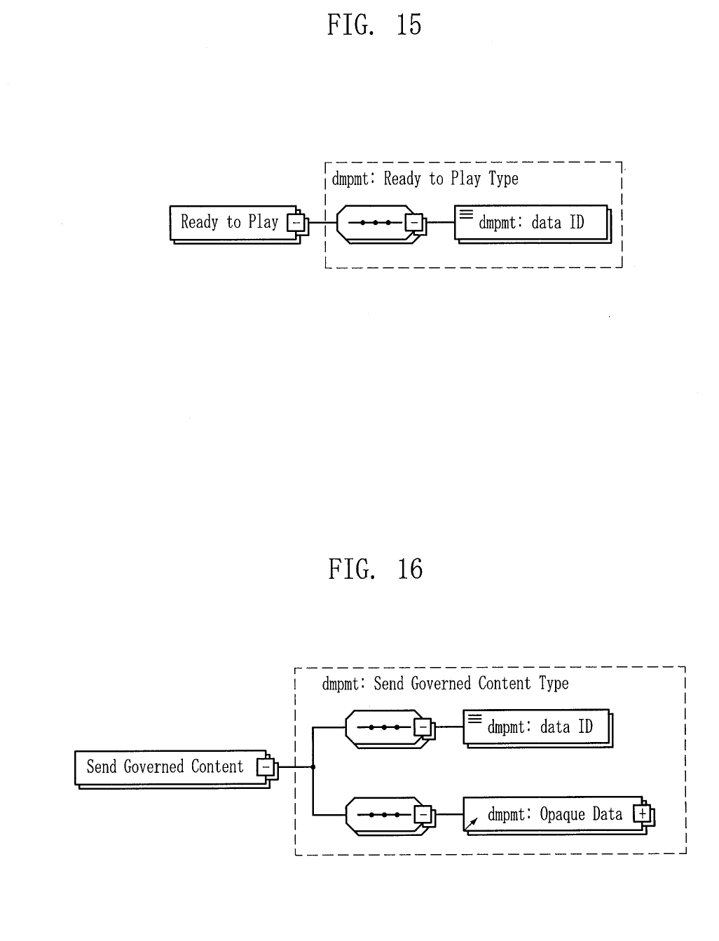

Then, the DRM message 306 obtains and analyzes DRM information from digital contents transferred from the content reproducing apparatus 304 at step S15, searches a corresponding tool pack 312 at step S16, and activates the searched tool pack 312 at step S17. Accordingly, the DRM processor 306 transmits a ready to play message to the content reproducing apparatus 304 at step S18 because all preparing processes are completely performed. FIG. 15 shows an XML schema structure of the ready to play message transmitted at step S18.

After receiving the ready to play message from the DRM processor 306, the content reproducing apparatus 304 transmits protected digital contents to the DRM processor 306 and requests the DRM processor 306 to de-package at step S19 until the corresponding digital contents are completely reproduced. The DRM processor 306 requests the tool pack 312 to convert at step S20. The tool pack 312 de-packages DRM from the digital contents and transmits the transformed digital contents to the DRM processor at step S21. The digital processor 306 transfers the transformed digital contents to the content reproducing apparatus 304 at step S22.

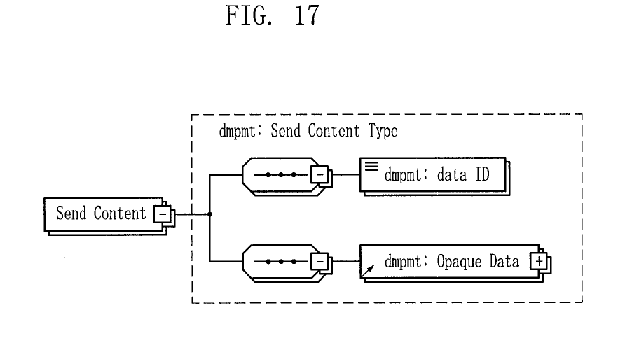

FIG. 16 illustrates XML schema structures of messages transmitted at the steps S19, and S20, and FIG. 17 illustrates XML schema structures of messages transmitted at steps S21 and S22.

What is claimed is:

1. A method of reproducing digital contents with Digital Rights Management (DRM) tool at a user terminal, comprising the steps of:
obtaining information about a DRM processor from the digital contents, selecting a DRM processor according to the obtained information, and driving the selected DRM processor;
initializing the DRM processor through exchanging messages between the user terminal and the DRM processor; and
transforming the digital contents with the DRM tool to original digital contents by activating a DRM tool using the initialized DRM processor and reproducing the original digital contents.

2. The method of claim 1, wherein the DRM processor information includes an identifier of a DRM processor; and a Uniform Resource Locator (URL) of a remote server from which a DRM processor is downloaded, or a binary code of a DRM processor.

3. The method of claim 1, wherein the messages in the initialization step include:
a first message transferred to the user terminal by the DRM processor for asking whether the digital contents are broadcasting contents or not; and
a second message transferred to the DRM processor by the user terminal for responding to the first message.

4. The method of claim 1, wherein the messages in the initialization step include:
a third message transferred to the user terminal by the DRM processor for requesting data size if the digital content is a file type or a packet identifier PID if the digital contents are broadcasting or multicasting, as data including DRM information; and
a fourth message transferred to the DRM processor by the user terminal for responding to the third message.

5. The method of claim 1, wherein the messages in the initialization step include:
a fifth message transferred to the user terminal by the DRM processor for asking where additional information of the DRM is stored in the user terminal; and
a sixth message transferred to the DRM processor by the user terminal for responding to the fifth message.

6. The method of claim 1, wherein the messages in the initialization step include a seventh message transferred to the user terminal by the DRM processor for informing that the DRM processor is ready to reproduce contents.

7. An apparatus for reproducing digital contents
with a DRM tool applied, comprising:
a DRM processor selected and driven according to DRM processor information obtained from the digital contents for activating a DRM tool according to the digital contents and transforming the digital contents with the DRM tool to original digital contents;
an initialization means for initializing the DRM processor through exchanging messages with the DRM processor; and
a reproduction means for reproducing the digital contents transformed by the DRM processor.

8. The apparatus of claim 7, wherein the DRM processor information includes an identifier of a DRM processor, and a Uniform Resource Locator (URL) of a remote server from which a DRM processor is downloaded, or a binary code of a DRM processor

9. The apparatus of claim 7, wherein the messages include:
a first message transferred to the user terminal by the DRM processor for asking whether the digital contents are broadcasting contents or not; and
a second message transferred to the DRM processor by the user terminal for responding to the first message.

10. The apparatus of claim 7, wherein the messages include:
a third message transferred to the user terminal by the DRM processor for requesting data size if the digital content is a file type or a packet identifier PID if the digital contents are broadcasting or multicasting, as data including DRM information; and
a fourth message transferred to the DRM processor by the user terminal for responding to the third message.

11. The apparatus of claim 7, wherein the messages include:
a fifth message transferred to the user terminal by the DRM processor for asking where additional information of the DRM is stored in the user terminal; and
a sixth message transferred to the DRM processor by the user terminal for responding to the fifth message.

12. The apparatus of claim 7, wherein the messages include a seventh message transferred to the user terminal by the DRM processor for informing that the DRM processor is ready to reproduce contents.

13. A data structure for storing information about a DRM processor in a digital content reproducing apparatus, comprising:
an identifier of the DRM processor; and
a uniform resource locator (URL) of a remote server from which the DRM processor is download or a binary code of the DRM processor.

14. A method for initializing a DRM processor in a digital content reproducing apparatus having the DRM processor according to input digital contents, comprising the steps of:
transferring a message to the digital content reproducing apparatus from the DRM processor for asking whether the digital contents are broadcasting contents or not; and
transferring a message from the digital content reproducing apparatus to the DRM processor for responding to the transferred message.

15. A method for initializing a DRM processor in a digital content reproducing apparatus having the DRM processor according to input digital contents, comprising the steps of:
transferring a message to the user terminal by the DRM processor for requesting data size if the digital content is a file type or a packet identifier PID if the digital contents are broadcasting or multicasting, as data including DRM information; and
transferring a message transferred to the DRM processor by the user terminal for responding to the message.

16. A method for initializing a DRM processor in a digital content reproducing apparatus having the DRM processor according to input digital contents, comprising the steps of:
transferring a message to the user terminal by the DRM processor for asking where additional information of the DRM is stored in the user terminal; and
transferring a message to the DRM processor by the user terminal for responding to the message.

17. A method for initializing a DRM processor in a digital content reproducing apparatus having the DRM processor according to input digital contents, comprising the step of:
transferring a message to the user terminal by the DRM processor for informing that the DRM processor is ready to reproduce contents.
